(19) United States
(12) Patent Application Publication
(10) Pub. No.: US 2007/0213411 A1
(43) Pub. Date: Sep. 13, 2007

(54) Dispersions And Methods Of Preparing Them

(75) Inventors: Mathew James Francis, Curtin (AU); Richard Mark Pashley, Cook (AU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Australian National University, Acton (AU)

(21) Appl. No.: 10/578,273

(22) PCT Filed: Nov. 5, 2004
(86) PCT No.: PCT/AU04/01536

§ 371 Date: Jan. 5, 2007

Related U.S. Application Data
(63) Continuation of application No. 10/703,094, filed on Nov. 5, 2003.

(30) Foreign Application Priority Data
Sep. 23, 2004 (AU) 2004905501

(51) Int. Cl. B01F 17/00

(52) U.S. Cl. 516/53

(57) ABSTRACT

The present invention relates to dispersions of hydrophobic pharmaceutically active agents in an aqueous phase and methods for preparing them. Advantageously, the dispersions may be substantially free of additional surfactants, dispersants and stabilizers.

### FIELD OF THE INVENTION

The present invention relates to methods of dispersing hydrophobic pharmaceutically active agents in an aqueous phase and to dispersions obtained thereby. The invention also provides dispersions of hydrophobic pharmaceutically active agents in an aqueous phase. Advantageously, preferred embodiments of the invention circumvent the need for additional surfactants, stabilizers or dispersants. The dispersions may provide new and effective drug delivery systems.

### BACKGROUND TO THE INVENTION

Many drugs are derived from natural products and generally have a high degree of complexity in their structure; because of this they are usually water-insoluble oils or solids, lacking the necessary polar nature to dissolve in water. This is a major problem for the pharmaceutical industry, as many drugs cannot be taken past the testing phase of approval, as suitable aqueous-based drug delivery systems cannot be easily formulated (Bodor, Chemical Aspects of Drug Delivery Systems; Karsa, D. R., Stephenson, R. A., Eds; Royal Society of Chemistry: London, 1996). For the drugs where suitable solvent systems can be found this is usually achieved by placing the drug in a highly insoluble carrier oil, which is then partially dispersed in water either with the aid of a chemical surfactant or meta-stably dispersed with the aid of physical agitation. A major side-effect is that upon introduction to the blood stream the oils used are often harmful to the body in high quantities or must be used quickly to achieve the dose required before the meta-stable dispersion breaks down. However the most harmful side effect is the presence of possible surfactant degradation products from the oils (or the chemical stabilizing surfactants) that can pose their own problems such as the hemolytic cleavage of cells (Davis, Interdisciplinary Science Reviews 25 (3): 175-183, 2000). The ability to directly disperse hydrophobic oils or the drug in water is therefore very beneficial to the pharmaceutical industry.

One example of an insoluble drug is the highly insoluble anticancer drug, paciltaxel (Taxol). The lack of solubility in water is evident from the complex, mostly hydrocarbon structure shown below:

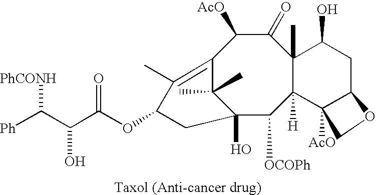

Taxol is soluble in soybean oil, which can then be dispersed in water with the aid of surfactants to stabilize the emulsion. The drugs used to treat cancer are often highly insoluble in water and as such current delivery systems involve either dispersing the drug into an appropriate drug delivery oil and then dispersing this into water or dispersing the drug directly into water and then injecting it intravenously, although the former is far more prevalent (Stuchlik, et al., Biomed. papers 145 (2): 17-26, 2001). The drug delivery oils used, such as soybean oil, are often unstable and hydrolyze causing harmful side effects in patients such as hemolytic cleavage of blood cells. Even low concentrations (2%) surface-active molecules in the total volume of the drug delivery oil can cause significant health problems (Spiteller, Medical Hypothese 60 (1): 69-83, 2003).

The current oils used for intravenous drug delivery are mainly derived from natural products including rapeseed and cottonseed oil, however the two most commonly used are soybean oil and castor oil (Stuchlik, et al., Biomed. papers 145 (2): 17-26, 2001). The structures of these two oils are shown below:

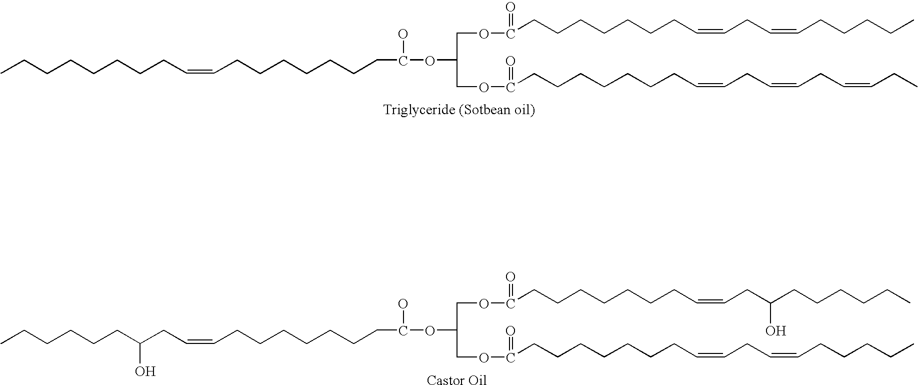

These two oils are used because they are hydrophobic, hence water-insoluble drugs will usually dissolve into them. These oils are currently used in industry, and it may well be that, the surfactant by-product produced by hydrolytic cleavage of the tri-ester linkage aids in the dispersion of the oil into the aqueous phase. However this beneficial side-product (the very thing aiding the process) is largely responsible for the harmful side effects and as such the industry monitors the purity of the oils carefully.

There exists, therefore, a need for pharmaceutically acceptable compositions comprising a dispersion of hydrophobic pharmaceutically active agent, such as a hydrophobic drug, in an aqueous phase, and methods for the preparation thereof, without the substantial use of additional stabilizers, surfactants or dispersants and preferably in the absence of such additives.

### SUMMARY OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

The natural hydrophobicity of many drugs makes it very difficult to use them for water-based intravenous injection. This lack of water solubility also hinders the development and testing of new drugs. Clinical tests are often refused if the drug can only be dissolved in water-insoluble oils and therefore cannot be administered safely or easily. It has now been discovered that de-gassing a mixture of a pharmaceutically acceptable hydrophobic drug and water (or one or both of these components prior to or during mixing) produces, on vigorous shaking, a uniform fine dispersion, in which one advantageous embodiment may be suitable for intravenous injection. These dispersions are advantageously stable and yet, preferably do not require the use of added stabilizing agents, such as surfactants and polymers, which can lead to harmful side effects. These dispersions may offer safer drug delivery systems and also might be used in facilitating the development or testing of new experimental, water-insoluble drugs. This novel process has been used to enhance the dispersion of the commonly used drug delivery oils, soybean oil and perfluorooctyl bromide (PFOB). This process can also be applied to other drug delivery oils, which are immiscible with water. For example, the dispersion of perfluorohexane in water is greatly improved by de-gassing. Over time, the dispersions phase separate but are easily re-generated simply by shaking, when stored under de-gassed conditions in sealed vials. In one embodiment, the process has also been successfully applied to the hydrophobic drug Propofol, where dispersion was obtained without the use of carrier oil or added dispersants.

Accordingly, one aspect of the present invention provides a method for preparing a dispersion of a hydrophobic pharmaceutically active agent in an aqueous phase comprising:
a) combining said agent and aqueous phase to form a mixture; and
b) before, during or after said combining, removing dissolved gases from one or both of the active agent and aqueous phase.

Optionally, the active agent may first be dissolved or dispersed in a suitable pharmaceutically acceptable hydrophobic carrier oil or liquid.

In a preferred embodiment, the method provides a method for dispersing a hydrophobic pharmaceutically active agent in an aqueous phase comprising:
a) combining said agent and aqueous phase to form a mixture; and
b) removing dissolved gases from said mixture.

The process of removing the gas from a mixture of the agent and aqueous phase, may result in spontaneous dispersion of the agent in the aqueous phase. Alternatively, the dispersion may be generated, or regenerated after settling, by agitating or shaking the mixture, still under vacuum.

Thus, in a further embodiment, the method comprises the additional step of:
c) agitating or shaking the degassed mixture to form a dispersion.

Another aspect of the invention provides a dispersion of a hydrophobic pharmaceutically active agent in an aqueous phase, substantially free of additional stabilizers, surfactants and dispersants. Another aspect provides a dispersion substantially free of dissolved gases or a dispersion wherein the agent or agent+carrier and/or aqueous phase are substantially free of dissolved gases.

In a preferred embodiment, the invention provides a drug delivery system comprising a hydrophobic pharmaceutically active agent in an aqueous phase, said drug delivery system substantially free of additional stabilizers, surfactants and dispersants. In another embodiment, the drug delivery system is substantially free of a carrier for the drug (other than the aqueous phase).

Yet another aspect of the invention relates to a dispersion or drug delivery system obtainable by the methods described herein.

Emulsions prepared by the methods described herein may advantageously contain droplets having a higher surface tension than emulsions prepared by other methods. Typically such droplets will have an interfacial tension in the range of 15-55 mJm⁻². These droplets will be more rigid and may advantageously facilitate drug delivery in, for example, injectable or aerosol applications by reducing shear-induced droplet coalescence which may result in increased viscosity of the emulsion.

Accordingly, another aspect of the invention provides a dispersion of droplets consisting of or containing a hydrophobic pharmaceutically active agent in an aqueous phase wherein the droplets have an interfacial tension of about 15-55 mJm⁻².

### BRIEF DESCRIPTION OF THE FIGURES

FIG. 1 graphically depicts the effect of degassing on the turbidity of dispersions of 0.2 ml soybean oil in 25 ml water.

FIG. 2 graphically depicts the effect of degassing on droplet size distribution of dispersions of purified and raw (unpurified) samples of soybean oil in water (0.2 ml/25 ml) 1 hour after vigorous shaking.

FIG. 3 graphically depicts droplet size distribution of dispersions (not degassed) of soybean oil in water (0.2 ml/25 ml) 20 minutes after vigorous shaking.

FIG. 4 graphically depicts the effect of degassing on the turbidity of dispersions of PFOB in water (0.2 ml/25 ml).

FIGS. 5 and 6 graphically depict droplet size distribution of degassed and gassed dispersions, respectively, of PFOB in water (0.2 ml/25 ml) 1 hour after vigorous shaking.

FIG. 7 graphically depicts the effect of degassing on the turbidity of dispersions of perfluorohexane in water (0.2 ml/25 ml).

FIG. 8 photographically depicts degassed (left) versus gassed (right) dispersions of propofol in water (0.2 ml/25 ml) 1-2 minutes after vigorous shaking.

### DESCRIPTION OF THE INVENTION

As used herein “hydrophobic pharmaceutically active agent” refers to pharmaceutically or biologically active agent having limited solubility in water or a substantially aqueous phase and is intended to include any hydrophobic or water immiscible physiologically active drug or agent which elicits a physiological effect in a subject upon administration. The drug or agent may be liquid, oil or solid. Examples of classes of hydrophobic pharmaceutically active agents contemplated by the invention include, but are not limited to, analgesics and anti-inflammatory agents, anthelmintics, anti-arrhythmic agents, anti-coagulants, anti-bacterial agents, anti-depressants, anti-diabetics, anti-epileptics, anti-fungal, anti-muscarinic agents, anti-neoplastic or anti-cancer agents and immunosuppressant, anti-protazoal agents, anti-thyroid agents, anxiolytic, sedatives, hypnotics and neuroleptics, ∃-Blockers, cardiac inotropic agents, corticosteroids, diruetics, anti-parkinsonian agents, gastro-intestinal agents, histamine H,-receptor antagonists, lipid regulating agents, nitrates and other anti-anginal agents, nutritional agents, opioid analgesics, hormones (including sex hormones), lung aerators, blood substitutes and stimulants. Some non-limiting examples thereof include:

Analgesics and anti-inflammatory agents: aloxiprin, auranofin, azapropazone, benorylate, diflunisal, etodolac, fenbufen, fenoprofen calcim, flurbiprofen, ibuprofen, indomethacin, ketoprofen, meclofenamic acid, mefenamic acid, nabumetone, naproxen, oxyphenbutazone, phenylbutazone, piroxicam, sulindac.

Anthelmintics: albendazole, bephenium hydroxynaphthoate, cambendazole, dichlorophen, ivermectin, mebendazole, oxamniquine, oxfendazole, oxantel embonate, praziquantel, pyrantel embonate, thiabendazole.

Anti-arrhythmic agents: amiodarone, disopyramide, flecainide acetate, quinidine sulphate.

Anti-bacterial agents: benethamine penicillin, cinoxacin, ciprofloxacin, clarithromycin, clofazimine, cloxacillin, demeclocycline, doxycycline, erythromycin, ethionamide, griseofulvin, imipenem, nalidixic acid, nitrofurantoin, rifampicin, spiramycin, sulphabenzamide, sulphadoxine, sulphamerazine, sulphacetamide, sulphadiazine, sulphafurazole, sulphamethoxazole, sulphapyridine, tetracycline, trimethoprim.

Anti-coagulants: dicoumarol, dipyridamole, nicoumalone, phenindione.

Anti-depressants: amoxapine, maprotiline, mianserin, nortriptyline, trazodone, trimipramine maleate.

Anti-diabetics: acetohexamide, chlorpropamide, glibenclamide, gliclazide, glipizide, tolazamide, tolbutamide.

Anti-epileptics: beclamide, carbamazepine, clonazepam, ethotoin, methoin, methsuximide, methylphenobarbitone, oxcarbazepine, paramethadione, phenacemide, phenobarbitone, phenytoin, phensuximide, primidone, sulthiame, valproic acid.

Anti-fungal agents: amphotericin, butoconazole nitrate, clotrimazole, econazole nitrate, fluconazole, flucytosine, griseofulvin, itraconazole, ketoconazole, miconazole, natamycin, nystatin, sulconazole nitrate, terbinafine, terconazole, tioconazole, undecenoic acid.

Anti-gout agents: allopurinol, probenecid, sulphin-pyrazone.

Anti-hypertensive agents: amlodipine, benidipine, darodipine, dilitazem, diazoxide, felodipine, guanabenz acetate, isradipine, minoxidil, nicardipine, nifedipine, nimodipine, phenoxybenzamine, prazosin, reserpine, terazosin.

Anti-malarials: amodiaquine, chloroquine, chlorproguanil, halofantrine, mefloquine, proguanil, pyrimethamine, quinine sulphate.

Anti-migraine agents: dihydroergotamine mesylate, ergotamine tartrate, methysergide maleate, pizotifen maleate, sumatriptan succinate.

Anti-muscarinic agents: atropine, benzhexol, biperiden, ethopropazine, hyoscyamine, mepenzolate bromide, oxyphencylcimine, tropicamide.

Anti-neoplastic and anti-cancer agents and Immunosuppressants: aminoglutethimide, amsacrine, azathioprine, busulphan, chlorambucil, cyclosporin, dacarbazine, estramustine, etoposide, teniposide, lomustine, melphalan, mercaptopurine, methotrexate, mitomycin, mitotane, mitozantrone, procarbazine, tamoxifen citrate, taxol, testolactone, daunomycin, doxorubicin.

Anti-protazoal agents: benznidazole, clioquinol, decoquinate, diiodohydroxyquinoline, diloxanide furoate, dinitolmide, furzolidone, metronidazole, nimorazole, nitrofurazone, ornidazole, tinidazole.

Anti-thyroid agents: carbimazole, propylthiouracil.

Anxiolytic, sedatives, hypnotics and neuroleptics: alprazolam, amylobarbitone, barbitone, bentazepam, bromazepam, bromperidol, brotizolam, butobarbitone, carbromal, chlordiazepoxide, chlormethiazole, chlorpromazine, clobazam, clotiazepam, clozapine, diazepam, droperidol, ethinamate, flunanisone, flunitrazepam, fluopromazine, flupenthixol decanoate, fluphenazine decanoate, flurazepam, haloperidol, lorazepam, lormetazepam, medazepam, meprobamate, methaqualone, midazolam, nitrazepam, oxazepam, pentobarbitone, perphenazine pimozide, prochlorperazine, propofol, sulpiride, temazepam, thioridazine, triazolam, zopiclone.

∃-Blockers: acebutolol, alprenolol, atenolol, labetalol, metoprolol, nadolol, oxprenolol, pindolol, propranolol.

Cardiac Inotropic agents: amrinone, digitoxin, digoxin, enoximone, lanatoside C, medigoxin.

Corticosteroids: beclomethasone, betamethasone, budesonide, cortisone acetate, desoxymethasone, dexamethasone, fludrocortisone acetate, flunisolide, flucortolone, fluticasone propionate, hydrocortisone, methylprednisolone, prednisolone, prednisone, triamcinolone.

Diuretics: acetazolamide, amiloride, bendrofluazide, bumetanide, chlorothiazide, chlorthalidone, ethacrynic acid, frusemide, metolazone, spironolactone, triamterene.

Anti-parkinsonian agents: bromocriptine mesylate, lysuride maleate.

Gastro-intestinal agents: bisacodyl, cimetidine, cisapride, diphenoxylate, domperidone, famotidine, loperamide, mesalazine, nizatidine, omeprazole, ondansetron, ranitidine, sulphasalazine.

Histamine H,-Receptor Antagonists: acrivastine, astemizole, cinnarizine, cyclizine, cyproheptadine, dimenhydrinate, flunarizine, loratadine, meclozine, oxatomide, terfenadine.

Lipid regulating agents: bezafibrate, clofibrate, fenofibrate, gemfibrozil, probucol.

Nitrates and other anti-anginal agents: amyl nitrate, glyceryl trinitrate, isosorbide dinitrate, isosorbide mononitrate, pentaerythritol tetranitrate.

Nutritional agents: betacarotene, vitamin A, vitamin B₂, vitamin D, vitamin E, vitamin K.

Opioid analgesics: codeine, dextropropyoxyphene, diamorphine, dihydrocodeine, meptazinol, methadone, morphine, nalbuphine, pentazocine.

Sex hormones: clomiphene citrate, danazol, ethinyl estradiol, medroxyprogesterone acetate, mestranol, methyltestosterone, norethisterone, norgestrel, estradiol, conjugated oestrogens, progesterone, stanozolol, stibestrol, testosterone, tibolone.

Stimulants: amphetamine, dexamphetamine, dexfenfluramine, fenfluramine, mazindol.

Under certain circumstances it may be advantageous or desirable to incorporate (dissolve or disperse) the drug and/or one or more other agents into a pharmaceutically acceptable hydrophobic carrier and disperse this mixture in the aqueous phase. Thus, the drug, either a liquid, oil or a solid, may be dispersed directly into the aqueous phase or dispersed or first dissolved in a hydrophobic carrier liquid or oil before dispersion into the aqueous phase. Suitable hydrophobic carriers include those physiologically inert or pharmaceutically acceptable carriers which have a water droplet contact angle of at least about 80°, preferably at least about 90° as described below, or alternatively are hydrocarbons of greater than 8 carbon atoms. Alternatively, carriers with a water solubility of less than about 0.1%, preferably less than 0.01% may be suitable. Carriers with a water solubility less than that of octane may be particularly suitable.

The degassing oil/water dispersion process is more effective with fully or substantially insoluble carrier liquids or oils rather then the partially soluble ones. This can be attributed to the fact that the more soluble oils undergo Ostwald ripening, allowing rapid oil droplet growth. The more hydrophobic an oil the better it is for use in methods described herein as Ostwald ripening cannot occur. A degree of hydrophobicity can be estimated by applying the Young's wetting equation to a theoretical liquid/liquid drop profile. A theoretical water droplet contact angle on the oil surface can be calculated, and if this angle is higher than about 80°, preferably higher than 90° then the oil is sufficiently hydrophobic. For example, for dodecane, the theoretical droplet contact angle is 110°. However, it should be noted that selection of a suitable carrier liquid or oil according to theoretical contact angles is a guide only and that liquids or oils having a theoretical contact angle of about 80° are not necessarily less preferred than those having a higher theoretical contact angle.

It was discovered (see later results) that for soybean oil the calculated (equilibrium) water droplet contact angle of 82° does not properly reflect its potential for enhanced dispersion on de-gassing. This is because rapid dispersion, on vigorous shaking, does not allow the interface time to stabilize. Thus, the large amphiphilic soybean molecule cannot readily orientate itself as a new water-oil interface is rapidly created. Thus the oil behaves more like a liquid hydrocarbon, with a correspondingly high, transient, interfacial tension. It is for this reason that de-gassing has a strong effect on soybean oil dispersion, making it particularly suitable for use in the present invention.

Fluorinated hydrocarbons, including perfluorocarbons make use of the particular strong C—F bond, which is even stronger when there are several fluorines bonded to a single carbon. These molecules are therefore quite inert which makes them potentially useful as drug delivery oils. A perfluorocarbon includes any fluorocarbon where the bulk (i.e. greater than 50%, say at least about 60%) of the non C—C bonds are C—F bonds. However, partially fluorinated hydrocarbons (having less than 50% of the non C—C bonds as C—F bond) are also contemplated by the invention. The structure of a typical linear perfluorocarbon molecule is shown below:

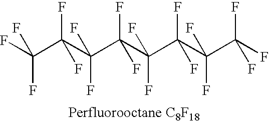

Another of the interesting aspects of perfluorocarbons is their high degree of hydrophobicity, which makes them perfect for the degassing process. Perfluorocarbons have a very low surface tension against air, while having a very high interfacial tension against water, this gives them a very high theoretical water droplet contact angle. This high water contact angle means that they are very hydrophobic (see following table) making them perfect candidates for the degassing process. Perflubron is the generic name for perfluorooctyl bromide (PFOB), a perfluorocarbon drug delivery oil commonly used in the pharmaceutical industry.

Physical Properties:

| | C₇F₁₆ | C₆F₁₄ | C₈F₁₈ | Perflubron |
|---|---|---|---|---|
| Interfacial tension | 39.7 | 38 | 42 | 47 |
| (mN/m) | | | | |
| Surface tension | 12.85 | 11.91 | 14.00 | 18 |
| (mN/m) | | | | |
| Density (g/ml) | 1.75 | 1.669 | 1.73 | 1.93 |
| Theoretical | 112° | 111° | 113° | 113° |
| contact angle | | | | |

Perfluorocarbons are capable of dissolving and carrying large amounts of physiologically essential gases, such as O₂ and N₂. They are therefore particularly useful either as a pharmaceutically active agent in themselves, to coat alveoli and facilitate oxygen transfer in the treatment of injured, immature/premature, diseased or otherwise non-fully functioning lungs, and/or as carriers for bronchodilators, antibiotics, etc, in the treatment of various lung disorders such as respiratory distress syndrome, asthma, emphysema and infections. Additionally, by taking advantage of its gas transport capacity, an aqueous emulsion of PFOB (droplets comprising a PFOB core, surrounded by lecithin) is currently under development for use as a blood substitute during surgery. Accordingly, aqueous dispersions of perfluorocarbons are of particular interest.

Thus, in certain embodiments of the invention, the hydrophobic pharmaceutically active agent or carrier is a perfluorocarbon. Examples thereof include, but are not limited to, perfluorohexane, perfluoroheptane, perfluorooctane, perfluorononane and PFOB.

Although perfluorocarbons are currently of significant medical use there is no easy or cheap way to deliver the drug intravenously. Currently, fluorocarbons are dispersed in a similar manner to hydrocarbons using, for example (in the case of perfluorooctyl bromide), a small amount of the fluorocarbon detergent perfluorodecyl bromide as dispersant oil, which is expensive and may be toxic to the kidneys. The present invention may advantageously circumvent or reduce the need for such a dispersant.

Other suitable carriers for use in the present invention may include those commonly used in the art of pharmacy and include soybean oil, castor oil, rapeseed oil and cottonseed oil. Particularly preferred carriers are soybean oil and perfluorocarbons.

The term “aqueous phase” includes water, or, where appropriate, mixtures of water and a water miscible or soluble solvent or compound. Suitable solvents might include alcohols (eg EtOH, PrOH) and DMSO.

As mentioned above, finely divided hydrocarbon oil/liquid droplets and fine hydrophobic particles generally will not adequately disperse and/or remain in dispersion without the addition of further surfactants, dispersants or stabilizers. Advantageously, the method aspect of the invention reduces, or more preferably circumvents, the need for the use of additional surfactants, stabilizers or dispersants. An aspect of the invention thus provides dispersions having significantly less (for example less than about 50% or less than about 20%, more preferably less than about 10%) of what might be typically used in the preparation of dispersion without degassing and are preferably substantially free of surfactants, stabilizers and dispersants. Surfactants, (or stabilizers or dispersants) are generally employed in the art in conjunction with carrier oils or liquids, typically 1-5% (v/v) of the hydrophobic liquid phase, which in itself is generally about 1% (v/v) of the aqueous dispersion. Therefore, one embodiment of the invention provides a dispersion having less than about 0.5-2.5% (w/v) or (v/v) of surfactant/stabilizer/dispersant in the hydrophobic phase (solid, liquid or oil). Preferred forms of the invention are substantially free of surfactants, stabilizers and dispersants, preferably containing less than about 0.25% of the hydrophobic phase, more preferably less than 0.1% of the hydrophobic phase. Particularly preferred forms contain no surfactants, stabilizers or dispersants.

A mixture can include an intimate combination of the agent or agent/carrier and aqueous phase or alternatively may include simply the two discrete phases in contact with one another or any level of admixture in between these. Thus, combining to form a mixture may include shaking, stirring or otherwise bringing one phase in contact with the other.

Optionally, the compositions or drug delivery systems of the invention may also comprise one or more additional additives or excipients such as flavourants, colourants, preservatives, buffers, isotonic agents and antioxidants. These may be incorporated into the composition or drug delivery systems at an appropriate stage, as necessary, dependent on whether they are hydrophobic or hydrophilic, either in the aqueous phase or with a suitable hydrophobic carrier, or after these components have been mixed or degassed. Such excipients or additives are known in the art of pharmacy (see for example, Remington's Pharmaceutical Sciences, 18^{th} Edition, Mack Publishing).

The drug to be dispersed in the aqueous phase may be a liquid or a solid at room temperature. Preferably, the solid for dispersion is a finely divided solid preferably of 2 μm or less, more preferably 1 μm or less and more preferably submicron particulate size, such as less than 0.5 μm, preferably about 0.4-0.3 μm.

Dispersions obtained by the methods of the invention advantageously afford colloidal emulsions which are substantially monodispersed having a droplet size of less than 2 μm, more preferably, 1 μm, preferably about 0.6-0.5 μm. Preferably, the resulting dispersions are stable for at least 1 hour, more preferably at least 3-4 hours or up to at least 24 hours. Dispersions may also be stable for at least 3-4 days, one week or 3-4 weeks. However, even when the formed dispersion separates, provided it has been stored under degassed conditions, it may readily be regenerated by simple shaking or agitation.

The dispersions are particularly suitable for use as injectable drug delivery systems as they are not readily subject to shear, and thereby may circumvent problems associated therewith, such as shear-induced droplet coalescence and increase in viscosity. The energy required to deform an oil droplet in water, through collisions or shear forces, depends on its size and its interfacial tension. The interfacial tension of hydrophobic droplets dispersed by the de-gassing process will typically be in the range of 15-55 mJm⁻², preferably in the range of 20-55 mJm⁻² and more preferably in the range of 30-50 mJm⁻². Particularly preferred interfacial tension values are in the range of about 45-50 mJm⁻². By comparison, a typical emulsion droplet, stabilized by added surfactants, has an interfacial tension of about 0.1 mJm⁻². The deformation energy required for the same size droplet will depend directly on the interfacial energy. Hence, de-gassed dispersions may have droplets with up to 150-550× higher surface tension, and hence rigidity compared with emulsion droplets. Hence drugs can be delivered in rigid sub-micron droplets: eg using finer syringes/aerosols than normal emulsions. In the blood stream the rigid spheres will also have a higher chemical potential of about 3× initially, due to the higher Laplace pressure and the thermodynamic relation: ∂μ=ΔP*V. However, this will fall and the particles will become more fluid as lipids and other amphiphilic molecules in the blood adsorb to the droplet surface and reduce the tension, probably facilitating drug release in the process. Hence, de-gassing should make the delivery process more robust.

Thus, dispersions containing droplets with an interfacial tension of, about 15-55 mJm⁻² are also contemplated herein. Interfacial tension measurements may be carried out by routine methods such as the drop-profile method, where the shape of one liquid droplet in another liquid is used to calculate the interfacial tension.

The skilled person will recognise that the concentration of active agent or agent+carrier in the aqueous phase will depend upon the nature of the agent and/or carrier and the ultimate form of and intended application of the dispersion. Appropriate concentrations can be determined by routine experimentation. Suitable concentrations of agent may lie in the range of about 0.001% (w/v) to about 5.0% (w/v), such as from about 0.01% to about 2.5% and may be dependent on whether the agent is directly dispersed in the aqueous phase or first dispersed or dissolved in a carrier. Concentrations of drug in the carrier may typically lie in the range of about 0.1% (w/v) to about 10% (w/v) such as about 0.1% to about 2.5%. Where a carrier is used, suitable concentrations of a carrier in the dispersion may include from about 0.1% (v/v) to about 5% (v/v) such as from about 0.5% (v/v) to about 2.5% (v/v) typically about 1% (v/v).

The methods of the invention may also advantageously, where desirable, allow for the preparation of drug delivery systems having an increased concentration of the desired drug when compared to know dispersion methods, such as those which utilise the use of additional surfactants, stabilizers or dispersants.

Dependent upon the nature of the agent and any carrier used, the mixture of agent and aqueous phase may spontaneously disperse during degassing. Alternatively, a further optional step in the methods of the invention involves the step of shaking or agitating the degassed mixture to form a dispersion.

The methods of the invention advantageously afford access to compositions suitable for use as drug delivery systems substantially free of stabilizers, surfactants and other dispersants. Such drug delivery systems may be presented for oral, rectal, nasal, inhalation, topical (including dermal, buccal and sublingual), vaginal or parental (including subcutaneous, intramuscular, intravenous and intradermal) use and may include other components known in the art of pharmacy. Particularly preferred drug delivery systems are for injectable use, or are presented in a form suitable for nasal administration or inhalation, such as aerosols.

Degassing may be carried out prior to, during or following the formation of a mixture by combining the individual phases. Thus, in one embodiment, the two phases are degassed separately and then shaken together under vacuum. Alternatively, the two phases may be combined and then degassed. In yet another embodiment degassing may occur as the two phases are brought into contact with one another to form the mixture.

In one embodiment the dissolved gases are removed from the agent/agent+carrier/aqueous phase (degassed) by the “freeze, pump, thaw” method. Thus, the agent or agent+carrier and aqueous phase, either individually or as a mixture, are frozen in liquid nitrogen and out-gassed by a vacuum pump. Following removal of the gas, the component(s) or mixture are then allowed to thaw and remaining dissolved gases are drawn into the space above the liquid. The “freeze, pump, thaw” cycle may be performed once or more preferably at least 2, 3, 4 or 5 times. On a larger scale, membrane separators and vacuum towers can be used to remove dissolved gases. Preferably at least 80% of dissolved gas is removed from the system, more preferably at least 90% or 95%. Most preferably at least 97 or 99% of dissolved gasses are removed and even more preferably at least 99.99%. A dispersion or drug delivery system or component thereof “substantially free of dissolved gases” refers to a dispersion or system or component thereof wherein at least 80% of dissolved gas is removed, more preferably at least 90% or 95%. Most preferably at least 99% of dissolved gasses are removed.

The invention also provides a method of enhancing the dispersion of a hydrophobic pharmaceutically active agent in an aqueous phase. “Enhancing” is intended to refer to the improved dispersion (as determined, for example, by turbidity measurements) and/or stability of an agent in an aqueous phase wherein one or both or the agent (optionally in a carrier) and aqueous phase has been degassed when compared to the corresponding non-degassed case.

The enhancement of oil droplet dispersion in water is most easily monitored using turbidity measurements. This enhancement can be measured by the difference between the new system (degassed) and the gassed blank, following vigorous shaking. In general, the gassed dispersion without the aid of stabilizing surfactants, is very unstable and phase separates readily, whereas the degassed mixture is far more stable and can take days to phase separate. Turbidity is a measure of how many droplets are dispersed in a given phase and is measured in NTU (nephelometric turbidity units) and in the results presented here is measured by light scattering. To give an understanding of the magnitude of these turbidity values, distilled water has a turbidity of 0.02 NTU, while tap water has a value of 1-2 NTU. Although useful, NTU measurements are of limited value and the results can be inaccurate if the refractive index of the dispersed phase is close to that of the dispersing phase (such as with perfluorocarbons in water) and so in some cases dynamic light scattering (DLS) has been used to obtain the droplet size distribution, as well as the charge on the oil droplets. However, careful interpretation of the DLS results is required for poly-disperse samples. Mono-disperse samples show size distribution by volume graphs (see later) over similar size ranges to the Z-average (diameter) and have a small PDI value (poly-dispersity index). The magnitude of the PDI is a measure of poly-dispersity. For poly-disperse samples the Z-average is the best estimate of average droplet size.

Although degassing enhances dispersion it is not stable indefinitely. The length of time a droplet is stable is obtained by simply balancing Stokes law with the force due to gravity. The balancing of these two forces determines the droplets settling rate, which is dependant on size and density relative to water. Once this is known along with the length of the tube, an approximate time for the duration of stability can be determined. It has been found, however, that the settling rate is only important for the amount of time that the dispersion is stable once shaken, since the original mixture and dispersion can be regenerated simply by vigorous shaking after the two phases separate, assuming that the mixture is stored in a sealed vessel under de-gassed conditions. Oil in water mixtures de-gassed in sealed glass tubes have so far been stored for up to 18 months and these still demonstrate enhanced dispersion on shaking. Once shaken and exposed to air, the dispersed droplets may remain dispersed for up to at least 24 hours, even though gas slowly then diffuses into the mixture. Thus, the dispersions or drug delivery systems of the invention are advantageous in that they may be stored for weeks or even months, and can be redispersed by shaking or agitation and releasing the vacuum (e.g. by breaking open the sealed ampoule in which it has been stored) prior to administration to the patient. A further aspect of this invention thus provides a method of delivering a hydrophobic pharmaceutical agent to a patient comprising administering to said patient a dispersion according to the invention.

The degassed dispersion was found to contain a mono-disperse droplet size distribution for insoluble hydrocarbon oils. This mono-dispersity can be attributed to the following factors: very small droplets have high velocities (from their kinetic energy) and as such have a higher tendency to collide and coalesce with other droplets. Larger droplets will settle out due to gravitational effects, as was mentioned in the previous section. This leaves a certain size of particle that is not fast enough to overcome the electrostatic repulsion and is too small to settle out quickly. The particles are stable and do not coalesce due to the fact that they are charged and cannot easily be forced together because of an electrostatic repulsion. It has been shown that even when high levels of salt (even above 0.2M) are added to the dispersion, once already formed, the oil droplets do not coalesce.

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

The following examples are provided for the purpose of illustrating certain embodiments of the invention and are not intended to limit the generality hereinbefore described.

### EXAMPLES

Materials and Methods

Soybean oil degradation products are surface active, which helps to stabilize the dispersion used for drug delivery. However, these surfactant side products are harmful to human cells and can also, upon agitation, produce a froth that can create its own problems once in the body. Currently before the soybean oil is loaded with a drug it is purified (USP grade) from the soybean. However, as mentioned previously, degradation products do form over time. Storing the soybean oil under cold conditions slows the hydrolysis process. If hydrolysis has occurred, it is generally easy to remove the carboxylate surfactant chains via a simple two-phase (solvent/water) separation. This purified version has been used here and compared with the non-purified sample.

Perfluorooctyl bromide, Perfluorohexane, Propofol and Griseofulvin were used as supplied. Water was prepared by activated charcoal and reverse osmosis filtration prior to distillation and storage in Pyrex vessels in a laminar flow filtered air cabinet.

Mixtures of oil and water were de-gassed by a process of repeated freezing in liquid nitrogen, followed by pumping down to a pressure of 0.01 mbar and then melting in a sealed tube. The dissolved gas produced on each melting cycle was removed on re-freezing. Although this process was carried out five times, typically no further de-gassing on melting was observed after 3-4 cycles. The vacuum pressure of 0.01 mbar corresponds to a de-gassing level of about 99.999%, if it is assumed that the final pressure achieved on several cycles of freeze/thaw/pumping is given by the pressure in equilibrium with the final frozen liquid, which on being melted does not give any visible bubbling/out-gassing. (It should be noted that membrane separators and vacuum towers are used to de-gas liquids commercially.)

Dispersion of oil in water was achieved by vigorous shaking of the mixture for 8 sec in a sealed Pyrex tube. Turbidity was measured using an HF Scientific Micro 100 Turbidimeter. Particle sizes and zeta potentials were measured using a Malvern Zetasizer.

Results

Soybean Oil

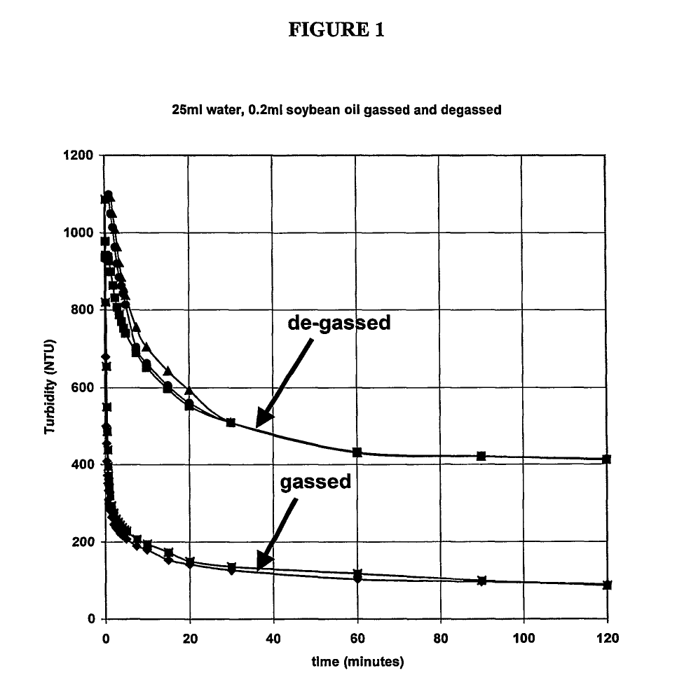

Degassed, purified soybean oil is substantially better dispersed in de-gassed water, following vigorous shaking, as is shown in FIG. 1. Purification also reduces the foaming of the soybean oil/water mixture due to a reduction in surfactant degradation products. As can be seen from the results in FIG. 1, the initial dispersion, within say the first minute or so, is substantially enhanced by de-gassing. The enhanced dispersion is maintained for several hours.

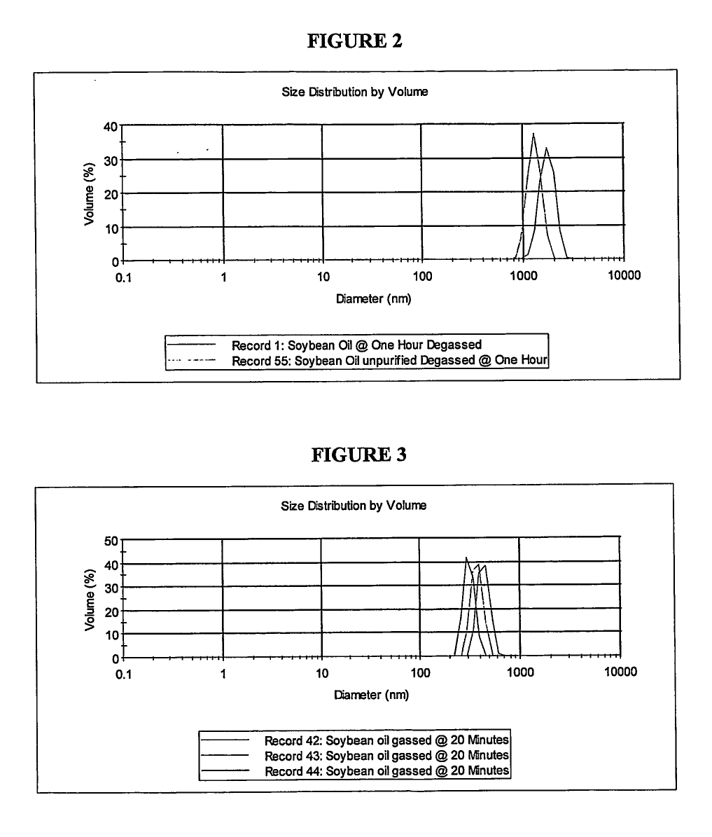

FIG. 2 shows the DLS results on the de-gassed purified and raw samples of soybean oil, 1 hour after vigorous shaking. The purified de-gassed oil gave smaller droplets (of average diameter 3 μm), with a narrower range of droplet size variation. Size graphs for purified (degassed) and unpurified soybean oil (degassed) at one hour (purified=1696 nm and unpurified=1282 nm)

PDI for purified=0.375 and Z-average size for purified=3165 nm

PDI for unpurified=0.534 and Z-average size for unpurified=5811 nm

FIG. 3 shows the droplet sizes for gassed (ie not degassed) soybean oil mixture 20 mins after vigorous shaking. After 1 hour the signal had no peaks and gave a PDI value of 1.0. Size Graphs for Soybean Oil (Gassed) at twenty minutes—the values at one hour were incomprehensible. (Diam=312.8 nm)

PDI=1.000 and Z-average size=5477 nm

The zeta potential of the soybean oil droplets was determined and showed an average value of −60 mV for the de-gassed case. For comparison, the zeta potential for unpurified, gassed soybean oil, was determined to be −13 mV.

Perfluorooctyl Bromide (PFOB)

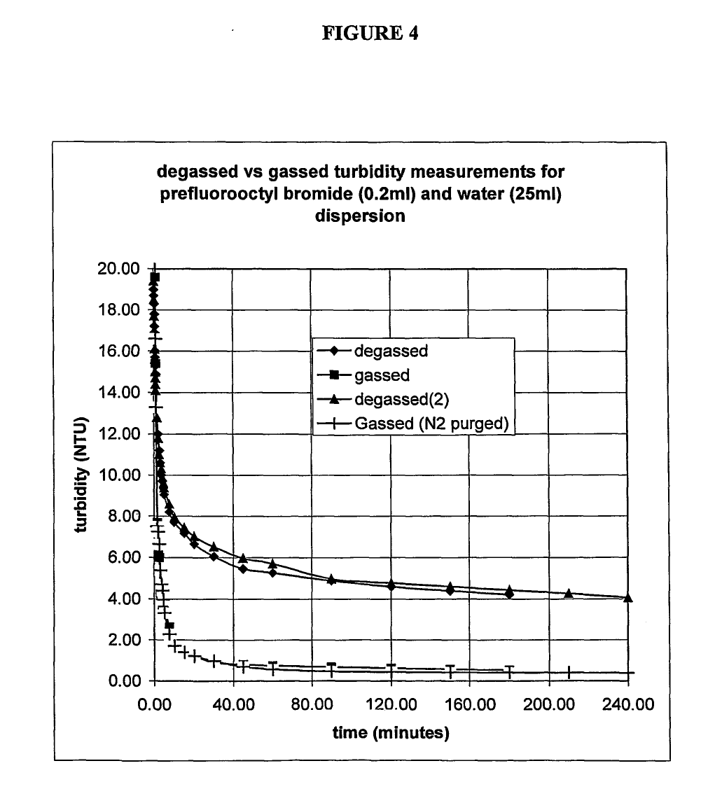

FIG. 4 sumrnmarizes the effect of de-gassing on the dispersion of this oil in water. Although the overall turbidity is much lower than for the soybean oil (because fluorocarbon oils have refractive indices close to water), the enhanced dispersion due to de-gassing is observed. The dispersion was maintained for the de-gassed mixture for many hours.

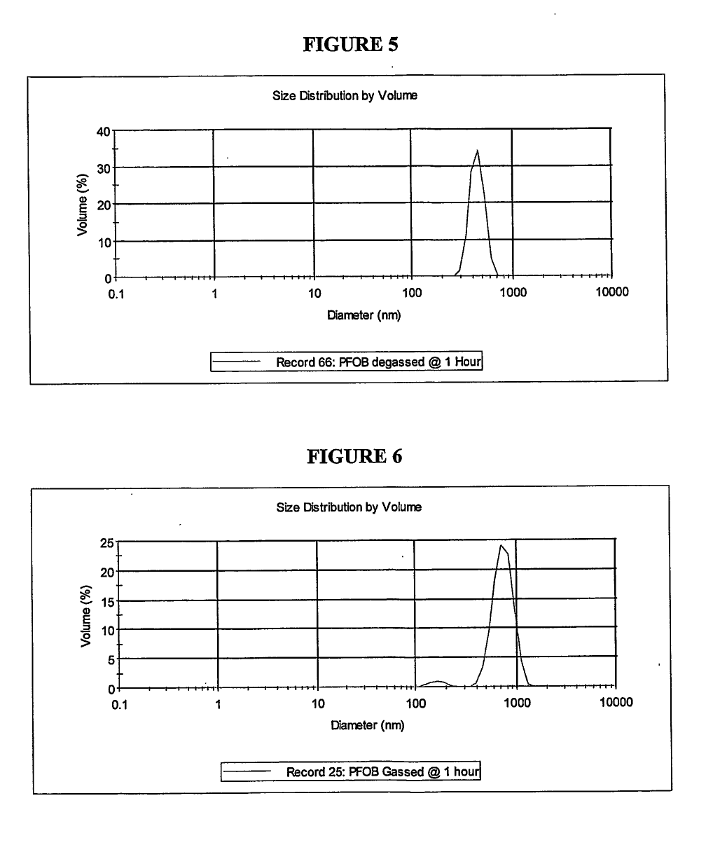

The size distribution for PFOB droplets 1 hour after vigorous shaking is shown in FIG. 5. The droplets have an average diameter of about 0.6 microns and a fairly narrow size distribution. Size Graph for Perflurooctyl Bromide (Degassed) at one hour (Diam 437.6 nm)

PDI=0.430, Z average size=599.6 nm

The corresponding distribution for the gassed case after 1 hour is shown in FIG. 6. In this case the droplets are bigger and seem to have a broader size distribution. Size graph for Perfluorooctyl Bromide (Gassed) at one hour (Diam 746.1 nm and 163.4 nm)

PDI=0.674 and Z-average size=1176 nm

The zeta potential for PFOB droplets of the de-gassed mixture was determined to be −42 mV.

Perfluorohexane

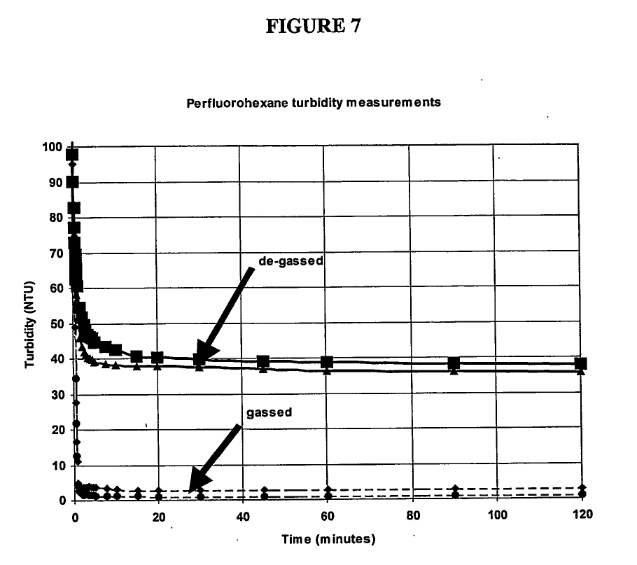

The effect of degassing on the dispersion of perfluorohexane is summarized in FIG. 7. Within less than a minute after vigorous shaking the gassed mixture phase separates into the oil and water, whereas the de-gassed mixture is readily dispersed and maintains its stability for many hours. The difference in turbidity is once again striking because of the simlarity in refractive index of the oil (1.29) and water (1.33).

Propofol

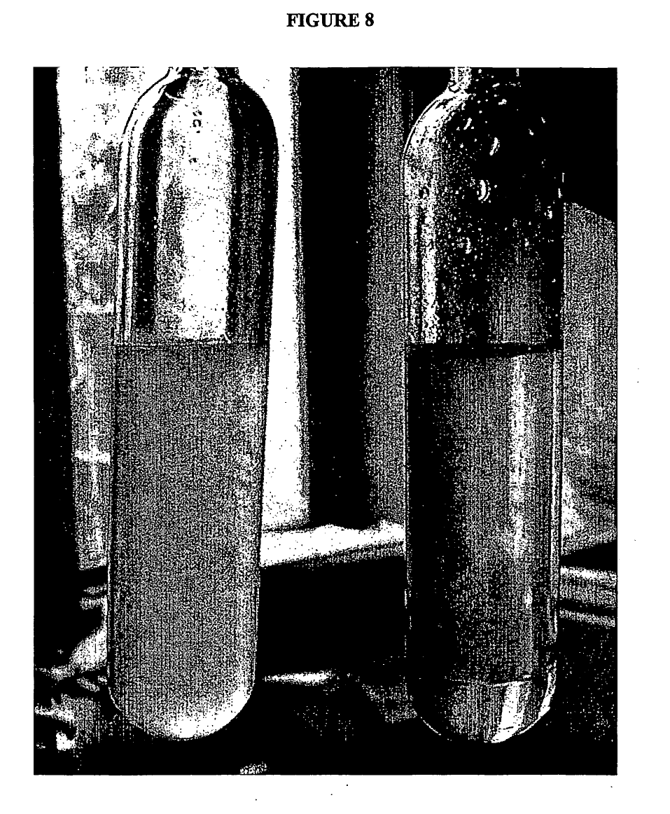

Propofol is a water insoluble oil, commonly used as a sedative. Currently, it is delivered intravenously by dissolving in an oil such as soybean and stabilized with added surfactants. Its chemical name is 2,6-diisopropyl phenol. The effect of de-gassing on the dispersion of this drug, in the absence of a carrier oil or added dispersants, was visually readily apparent (FIG. 8). The de-gassed mixture, showed complete dispersion of the oil, whereas the gassed case has many large, visible droplets of the oil. These results are consistent with those obtained on other hydrophobic liquids. In addition, as with other dispersions, it is most likely that the oil droplets will be of sub-micron size. The dispersion was observed to be stable over many hours, which indicates that the oil droplets must be fine. Advantageously, in this case, the drug may be delivered in an aqueous medium without the need for any additives. The turbidity of the de-gassed dispersion was monitored for several hours and the mixture was then exposed to high salt levels, above those found in human blood. The dispersion was unaffected by the addition of salt.

Griseofulvin

The white, finely powdered solid drug griseofulvin was dispersed (0.01 g in 25 ml) directly into water under both gassed and de-gassed conditions. The solid was clearly well dispersed in the degassed, cloudy solution, whereas solid clumps and a more transparent solution was observed for the gassed solution.

In addition, griseofulvin was dispersed in soybean oil, where 0.05 g griseofulvin was dissolved in 10 ml of soybean oil, of which 0.2 ml of this oil/solid solution was then dispersed in 25 ml water. The turbidity results obtained after dispersion, by vigorous shaking, were the same as those obtained for soybean oil alone.

These results demonstrate that solid, hydrophobic drugs can be dispersed directly in de-gassed water and that the addition of drugs into the carrier oil does not affect the de-gassed dispersion.

1. A method for preparing a dispersion of a hydrophobic pharmaceutically active agent in an aqueous phase comprising:
a) combining said agent and aqueous phase to form a mixture; and
b) before, during or after said combining, removing dissolved gases from one or both of the active agent and aqueous phase.

2. The method according to claim 1 comprising:
a) combining said agent and aqueous phase to form a mixture; and
b) removing dissolved gasses from said mixture.

3. The method according to claim 1 further comprising:
c) agitating or shaking the degassed mixture to form a dispersion.

4. The method according to claim 1 wherein said dispersion is substantially free of stabilizers, surfactants or dispersants.

5. The method according to claim 1 wherein said agent is an oil or liquid.

6. The method according to claim 5 wherein said agent is a perfluorocarbon.

7. The method according to claim 1 wherein the said agent is a finely divided solid.

8. The method according to claim 1 wherein said agent is first dissolved or dispersed in a pharmaceutically acceptable hydrophobic carrier oil or liquid.

9. The method according to claim 8 wherein the carrier oil or liquid is soybean oil or a perfluorocarbon.

10. The method according to claim 1 wherein at least 80-99.99% of dissolved gases are removed.

11. A dispersion of a hydrophobic pharmaceutically active agent in an aqueous phase, substantially free of dissolved gases.

12. A dispersion of droplets of a liquid or oily hydrophobic pharmaceutically active agent, or a hydrophobic pharmaceutically active agent dissolved or dispersed in a carrier oil or liquid, in an aqueous phase, wherein the droplets have are interfacial tension of about 15-55 mJm⁻².

13. A drug delivery system comprising a dispersion according to claim 11.

14. The drug delivery system of claim 13, wherein the dispersion is substantially free of stabilizers, surfactants and dispersants.

15. A drug delivery system comprising a dispersion according to claim 12.

16. The dispersion according to claim 12 wherein the droplets have an interfacial tension of about 30-50 mJm⁻².

17. The dispersion according to claim 11 wherein said agent is a finely divided solid.

18. The dispersion according to claim 11 wherein said agent is an oil or liquid.

19. The dispersion according to claim 18 wherein the agent is a perfluorocarbon.

20. The dispersion according to claim 11 wherein the agent is dissolved or dispersed in a pharmaceutically acceptable hydrophobic carrier oil or liquid.

21. The dispersion according to claim 20 wherein the carrier oil or liquid is soybean oil or a perfluorocarbon.

22. A drug delivery system according to claim 13 for injection.

23. A drug delivery system according to claim 13 for inhalation.

24. A method of delivering a hydrophobic pharmaceutically active agent to a patient in need thereof comprising administering to said patient a drug delivery system according to claim 13.

25. The method according to claim 24 wherein the drug delivery system is administered via injection.

26. The method according to claim 24 wherein the drug delivery system is administered via an aerosol.

27. A method for preparing a dispersion of a hydrophobic pharmaceutically active agent comprising the step of removing dissolved gases from a mixture of said agent and aqueous phase; and, optionally, agitating or shaking the degassed mixture.
